(19) United States
(12) Patent Application Publication
(10) Pub. No.: US 2019/0180217 A1
(43) Pub. Date: Jun. 13, 2019

(54) SYSTEM AND METHOD FOR BRINGING TOGETHER WORKERS WITH CLIENTS WHO NEED ASSISTANCE WITH TASKS

(71) Applicant: Michael Chunwei Chen, New Albany, OH (US)

(72) Inventor: Michael Chunwei Chen, New Albany, OH (US)

(21) Appl. No.: 16/217,496

(22) Filed: Dec. 12, 2018

Related U.S. Application Data
(60) Provisional application No. 62/597,461, filed on Dec. 12, 2017.

(51) Int. Cl. G06Q 10/06; G06Q 10/10

(52) U.S. Cl. CPC G06Q 10/063112; G06Q 10/1091

(57) ABSTRACT

A system and method for matching and bringing together workers with clients who need assistance with tasks. The method runs as an application on a mobile computing platform that allows clients to enter tasks and for workers (or “drones”) to sign up (or apply) for tasks. The method also allows the workers to submit and get paid for completed tasks. The application locates a first set of workers available for completing the task within a predetermined geographic distance from the location of the task. A graphical user interface displays a map with a symbol representing the location of the desired task and a plurality of selectable symbols, each of the plurality of selectable symbols representing workers available for completing the task.

### CROSS-REFERENCE TO RELATED APPLICATIONS

This application claims priority to U.S. Provisional Application No. 62/597,461 filed on Dec. 12, 2017 and is herein incorporated by reference in its entirety.

### BACKGROUND OF THE INVENTIVE FIELD

The present invention is directed to a system and method for bringing together workers with clients who need assistance with tasks. In the preferred embodiment, the system runs as an application on a mobile computing platform that allows clients to enter tasks and for workers (or “drones”) to sign up (or apply) for tasks. The system also allows the workers to submit and get paid for completed tasks.

### SUMMARY OF THE GENERAL INVENTIVE CONCEPT

In one embodiment of the invention, the invention is comprised of a method for displaying task information on a collection of graphical user interfaces relating to locating workers and facilitating the matching of clients with workers, selecting workers and authenticating work performance and attendance, the method comprising the steps of:

displaying a first space on the collection of graphical user interfaces for a first client to input a first task to be completed;

displaying a second space on the collection of graphical user interfaces for the first client to input a payment amount or hourly rate;

displaying a third space on the collection of graphical user interfaces for inputting a location of the first task;

(the date, time and duration may also entered by client)

locating a first set of workers available for completing the task within a predetermined geographic distance from the location of the first task;

displaying on a first map a first symbol representing the location of the first task;

displaying on the first map a plurality of selectable symbols, each of the plurality of selectable symbols representing one of the first set of workers available for completing the task;

displaying each of the plurality of selectable symbols at the location on the map where each of the first set of workers is located;

providing the ability to view the profile of each of the first set of workers available for completing the task;

providing the ability for the client to select one or more of the first set of workers to send a task request;

sending the selected one or more of the first set of workers a request to accept or decline the task request;

authorizing a first worker who accepts the task request;

tracking the time the first worker is at the location of the first task;

providing the ability for the first client to dispute task completion by the first worker;

providing the ability for the first client to dispute task initiation by the first worker based on the first worker's location;

dynamically changing the color of each of the plurality of selectable symbols representing one of the first set of workers based on whether the payment amount or hourly rate meets the minimum pay requirement of each of the first set of workers;

providing the ability for the first client to change the payment amount or hourly rate to a new payment amount or hourly rate; and

dynamically changing the color of each of the plurality of selectable symbols representing one of the first set of workers based on the new payment amount or hourly rate.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the navigation menu for drones (i.e., potential workers) and clients;

FIG. 2 illustrates one embodiment of a price setting screen that allows the drone worker to set minimum pay requirements for tasks;

FIG. 3 illustrates one example of a freestyle screen that allows the drone to search tasks by map or by list;

FIG. 4 illustrates one example of a freestyle screen that allows drones to view available tasks by map;

FIG. 5 illustrates one example of a task detail screen that shows what the task is, start and end times, locations, and other details;

FIG. 6 illustrates one example of a freestyle screen that allows drones to view available tasks by list;

FIG. 7 illustrates one example of a screen that allows clients to view a list of a client's favorite drones;

FIG. 8 illustrates an example screen that allows clients to enter tasks that require completion;

FIG. 9 illustrates an example screen that allows clients to search favorite drones by list;

FIG. 10 illustrates an example screen that allows clients to search drones by map;

FIG. 11 illustrates an example screen showing the ability to search for all drones by list;

FIG. 12 illustrates an example “Open Task” screen;

FIG. 13 illustrates an example screen illustrating the location of the task in relation to the location of the drone;

FIG. 14 illustrates a screen notifying a client that a selected drone has declined the task;

FIG. 15 illustrates a client screen of one embodiment of the invention showing the details of an open task;

FIG. 16 illustrates an example screen showing a pre-filled task form;

FIG. 17 illustrates an example screen showing an open tasks screen with an alert requiring the client to decide whether to schedule the drone and pre-authorize credit card, decline the drone, or determine the task is filled;

FIG. 18 illustrates an example screen listing scheduled tasks for a particular drone;

FIG. 19 illustrates an example screen providing task details for a scheduled task;

FIG. 20 illustrates one example of a screen allowing the client to indicate the task has been filled or to leave the task open to attract additional drones;

FIG. 21 illustrates an example screen allowing the drone to cancel a scheduled task;

FIG. 22 illustrates one example embodiment of a “Task in Progress-Task Details” screen;

FIG. 23 illustrates an example embodiment of the “Acknowledge or Dispute Task Initiation” screen;

FIG. 24 illustrates on example embodiment of a “Task in Progress” screen;

FIG. 25 illustrates an example screen interface allowing the filtering of tasks by category;

FIG. 26 illustrates an example screen for setting minimum pay requirements and setting special relationships;

FIG. 27 illustrates an example screen for setting the filter function built into the drone selection screens.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

The attached figures illustrate screen shots of one example embodiment of the invention. The attached figures illustrate example graphical user interfaces (GUI), for accomplishing the unique aspects of the present invention.

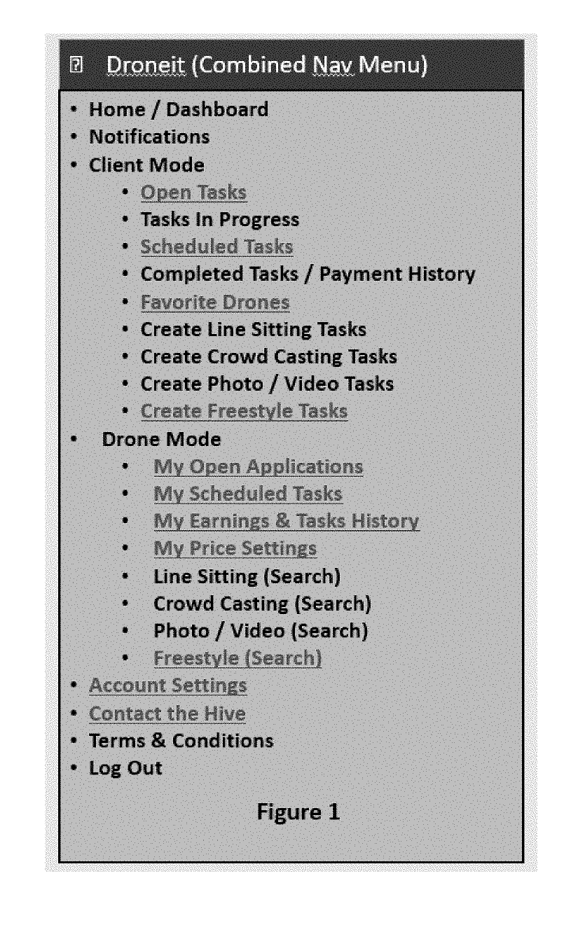

FIG. 1 illustrates one embodiment of a main navigation screen for drones (i.e., potential workers) and clients. In the preferred embodiment, both the drones and the clients are required to set up a profile and account before they are allowed access to the application. Businesses may also create profiles as client or drones. Drones must provide a bank account and clients must provide a credit card for payment purposes.

### Price Settings:

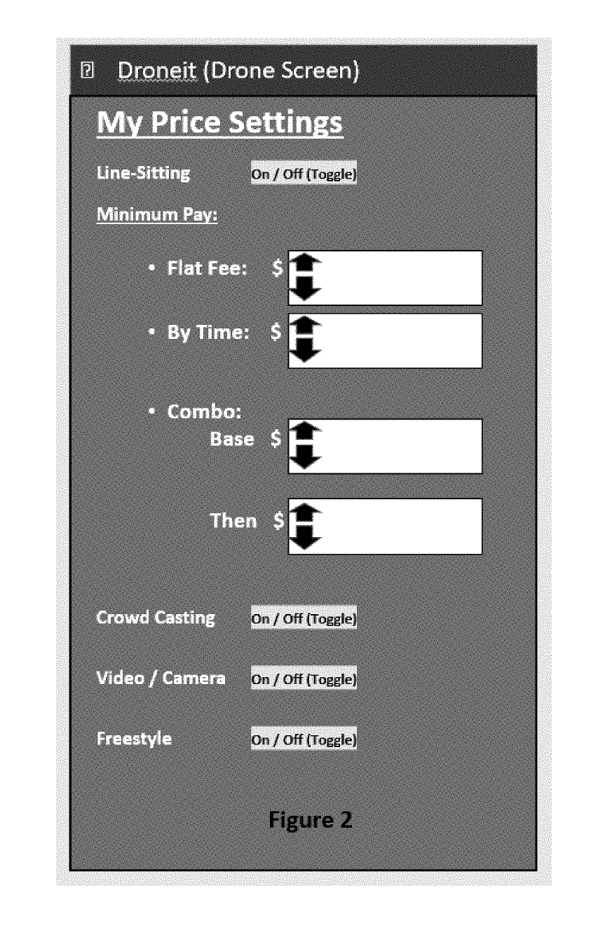

FIG. 2 illustrates one embodiment of a price setting screen that allows the drone worker to set minimum pay requirements for tasks. (In one embodiment, the client can also set prices for tasks). For example, “combo” prices are set when there is a base price and an hourly rate on top of the base price. In one example scenario, a client wants a drone to wait in line in the arena for tickets, but the drone is in a neighboring city. The drone has to drive all the way to downtown to accomplish the task. What if the client were to cancel the task before the drone starts the task? The app of the present invention gives the drone the option to ask for an initial flat fee that is collected prior to the task starting as long as the drone is in transit. The drones are not required to ask for a flat fee on top of an hourly rate but they have the option to do so with the present invention. In this example, the drone may ask for $20 flat fee and then $30 per hour of line sitting. The $20 would be incurred upon the drone heading to the task location (or having arrived at the task location) but the $30/hr would be earned based on a clock that doesn't start until the drone has reached the actual task location. In one embodiment, the client can see the drone on a map to verify that the drone is actually in the downtown district before the task begins.

### Freestyle Screen:

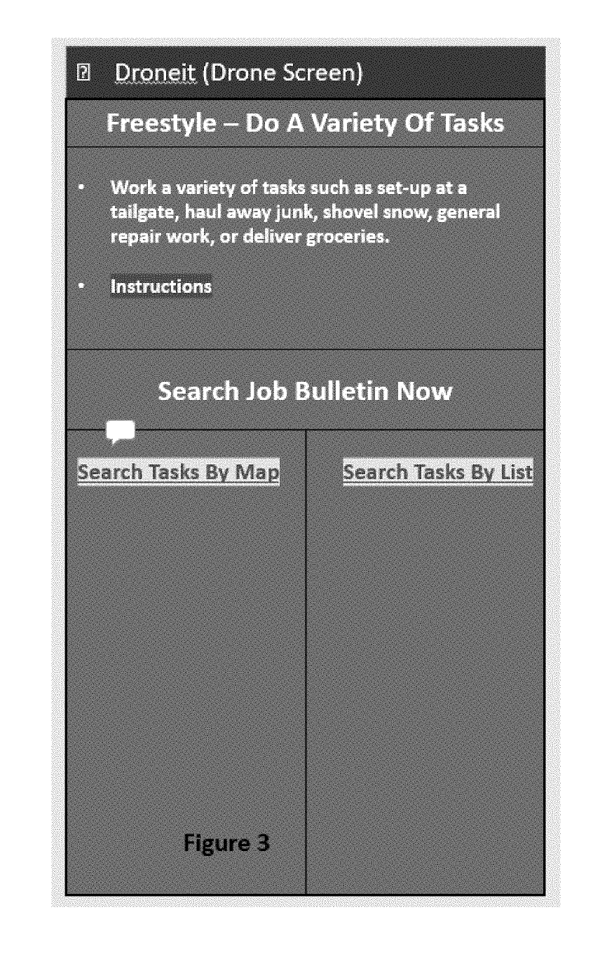

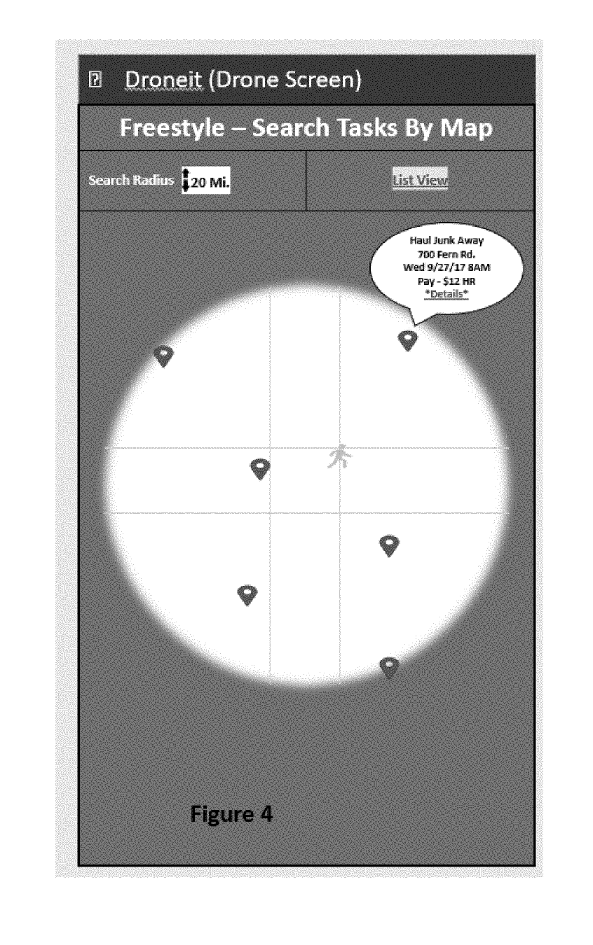

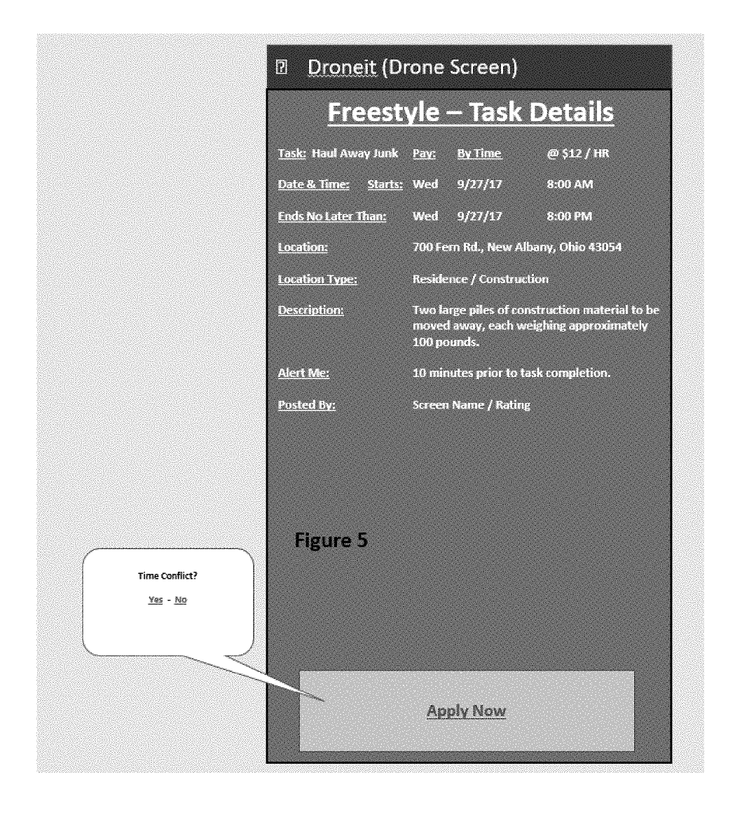

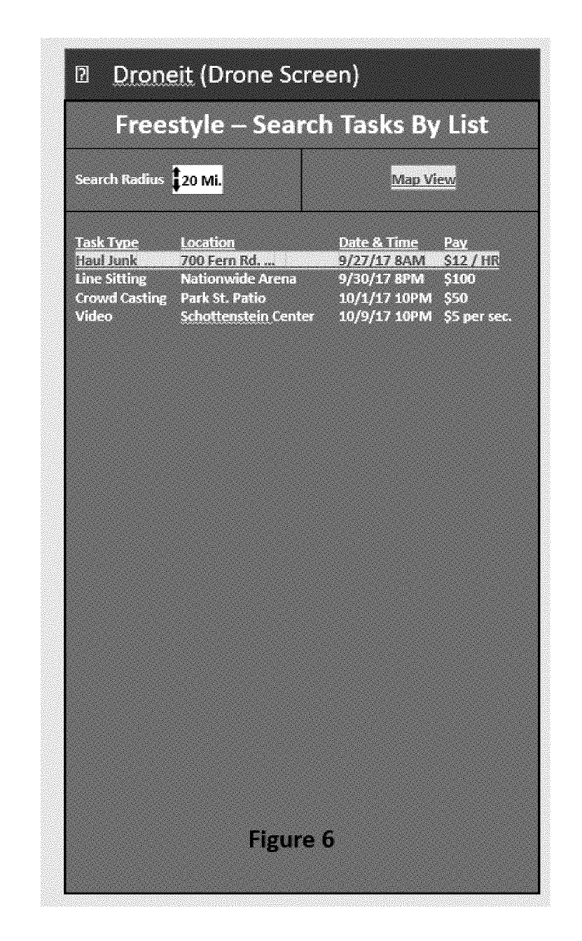

In one embodiment of the invention, the users will be provided a main menu (or “Home” screen) having four user selectable sections corresponding to 1) Line Sitting, 2) Crowd Casting, 3) Photo/Video Updates, 4) Freestyle (which is basically any other task). In the preferred embodiment, all 4 functions use the same basic protocol or functionality as described herein. Instead of duplicating the same functions for each column, the GUI has only been described for the “Freestyle” option. When a user clicks on the Freestyle link, it will take the user to a slide that states “Freestyle”—which is a page that briefly explains what Freestyle is about. The user can also navigate from each screen using the navigation menu (or “nav” menu (FIG. 1)). In this embodiment, the “nav” menu is only shown on the “Home” screen for simplicity, but can be available on all the screens. FIG. 3 illustrates one example of a freestyle screen that allows the drone to search tasks by map or by list. FIG. 4 illustrates one example of a freestyle screen that allows drones to view available tasks by map. The drone location is indicated by the “person” icon and task icons are displayed which may be clicked on (or hovered over) to view task details. FIG. 5 illustrates one example of a task detail screen that shows what the task is, start and end times, locations, and other details. The drone can apply for the task by clicking on the “apply now” link. From the task details, drones can apply for a task as long as there is not a time conflict with another task that was previously scheduled. FIG. 6 illustrates one example of a freestyle screen that allows drones to view available tasks by list. Each task is preferably selectable by the drone to view task details.

### Favorite Drones:

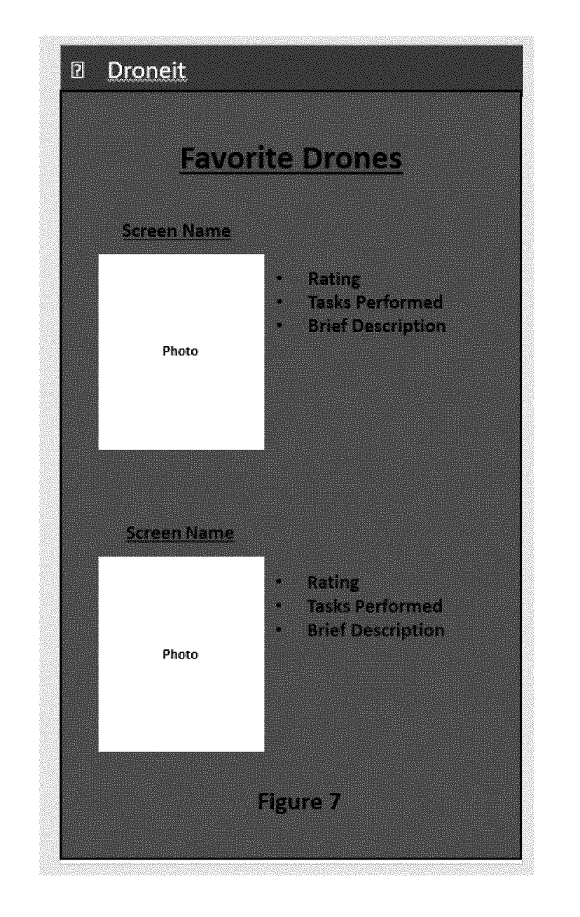

FIG. 7 illustrates one example of a screen that allows clients to view a list of a client's favorite drones. After the client fills out a task form (entering details of the What, When, Where, How, and How Much of a task) a client then has an option to select drones by using a) Map, b) List, or c) their favorite drones.

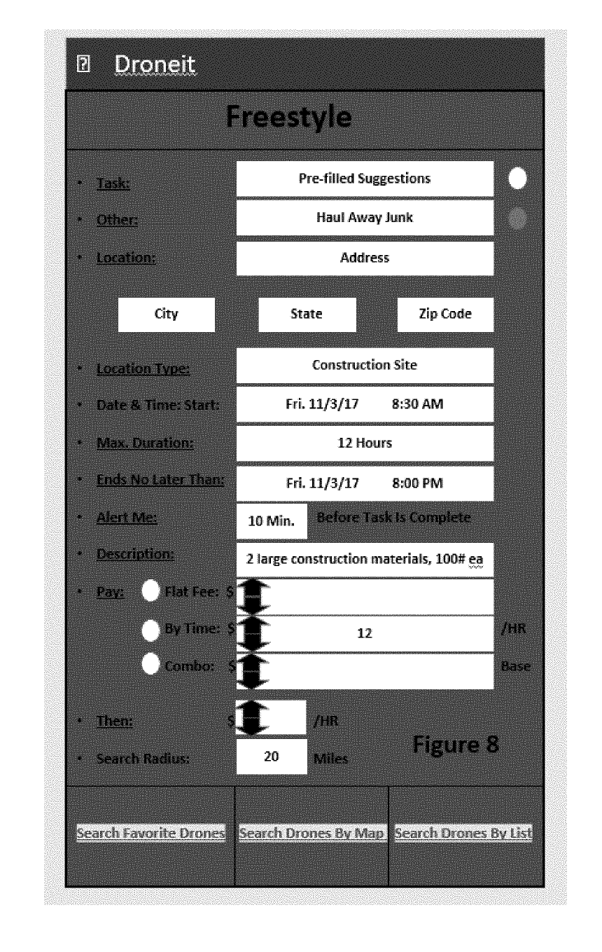

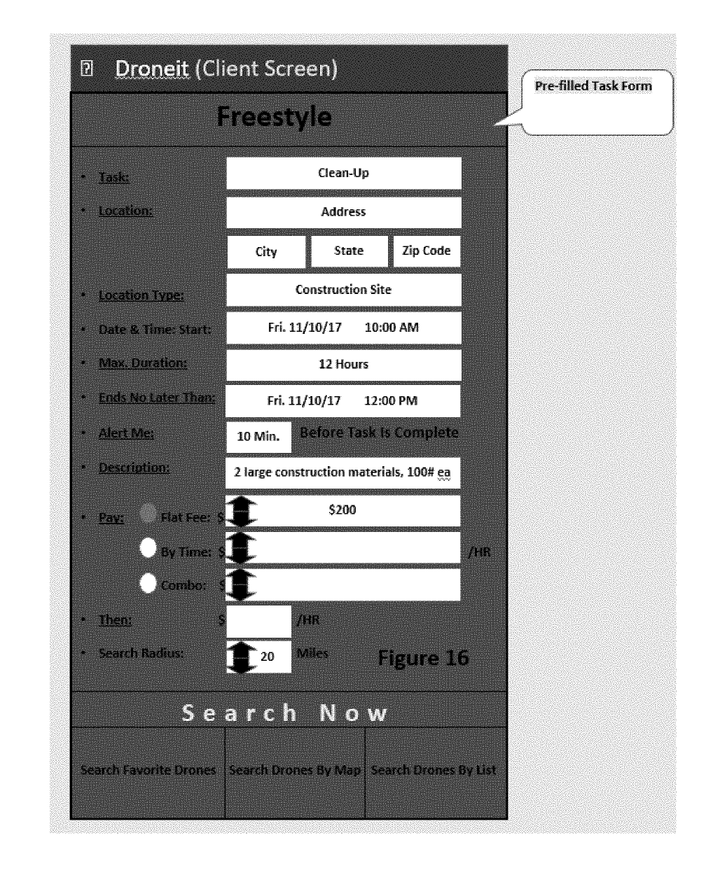

FIG. 8 illustrates an example screen that allows clients to enter tasks that require completion. In this embodiment, the client can set the payment for the task by flat fee, by hour, or by a combination of the two. FIG. 16 illustrates an example screen showing a pre-filled task form. Clients can use the pre-filled task form for jobs that recur frequently.

### Search Drones by Map:

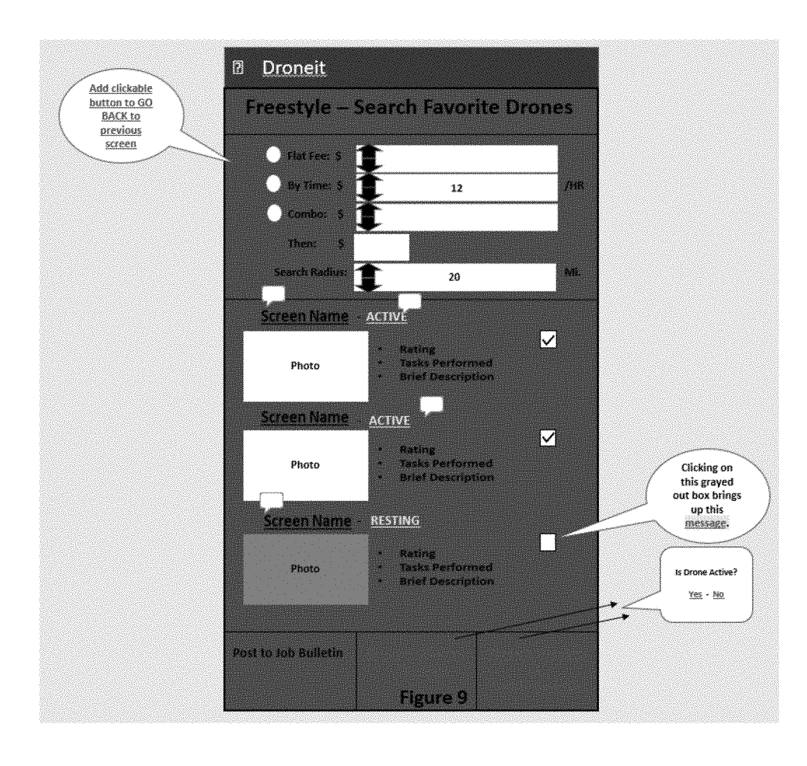

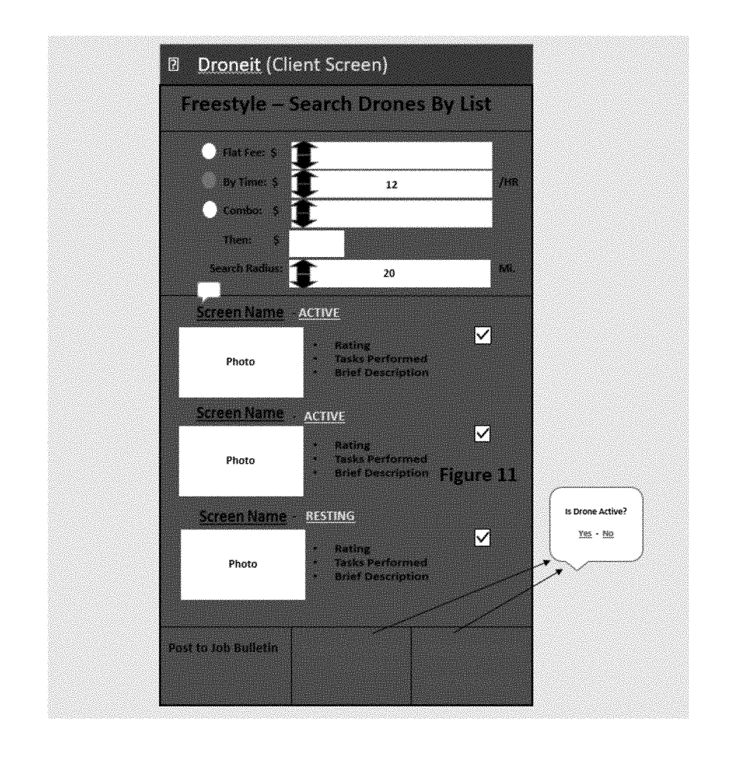

FIG. 9 illustrates an example screen that allows clients to search favorite drones. The list of favorite drones will indicate whether a drone is available to perform tasks at the payment amount entered. The screen allows the client to select available drones and to request them for the required task. The screen also allows the client to post the task to a virtual job bulletin where any drone may apply, or to simultaneously request the selected drones as well as post to the virtual job bulletin. If the client attempts to select a “greyed-out” drone, the app will indicate that the selected drone requires a higher pay. In one embodiment, the app will allow the client to adjust the payment apparatus while monitoring for changes in the drone's color, an indication that the payment amount entered has satisfied the drone's requirements. FIG. 11 illustrates the ability to search drones by list, which is similar to the screen of FIG. 9 (searching favorite drones) except it is showing the ability to select the drones. Note that in FIG. 11, the third drone on the list is no longer greyed out and can be selected (even if the drone is resting), indicating that the amount of pay entered by the client satisfies the drone's requirement.

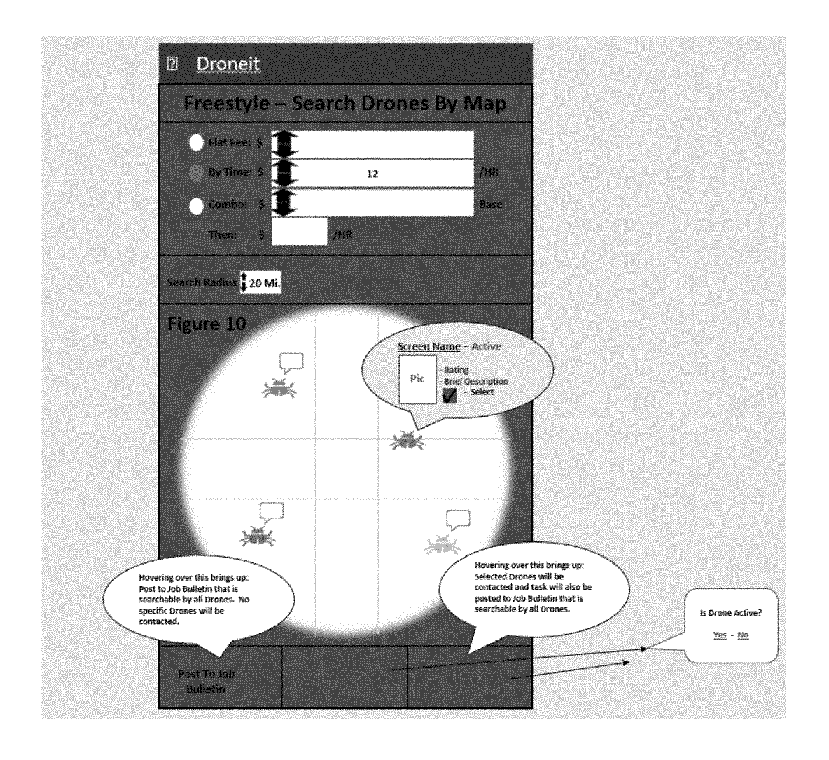

FIG. 10 illustrates an example screen that allows clients to search drones by map. In this screen, the available drones are shown on a map that is based on, or centered on, the task location (e.g., drones within a 20 mile radius of the task location). Drones are located by the system using geolocation or GPS services available on their mobile devices—which are tracked by the system. The fields above the map are for filtering purposes. For example, a client user can change the radius of the map and/or the pay. Changing these parameters will change the drones shown on the map. In this embodiment, based on the prices entered, the drones will dynamically change color. If the amount entered is below a drone's pay requirement, then it is shown in gray regardless of whether the drone is currently active or not. Once you click the up arrow and bring the pay above the drone's requirement, the drone will change colors (e.g., from gray to either orange or green). If the drone is inactive (or unavailable) but the amount entered meets its pay requirement, then the drone will be orange. If the drone is active and the amount entered meets the drone's requirement, then the drone will be green. The app also provides a screen, FIG. 11, to search and show the available drones by list, instead of a map, but with all the same filtering capabilities.

### Open Tasks/Selecting Drones Screen:

In all three drone selection screens (By Map, By List, By Favorite Drones), a client can click on a box to select a particular drone. The client can select multiple drones at the same time. Once the client is satisfied with the selection(s), the client can click on one of three buttons at the bottom of the screen: a) Post to job bulletin, b) Request selected drones, or c) Request selected drones and post to job bulletin. If the client simply clicks option a) Post to job bulletin, then the task will be posted to a virtual job bulletin which means that it will be available to be searched by any drone. Any drone may now apply for this task. However, no message will be sent to any of the specific drones. If the user simply clicks option b) Request selected drones, then a text/SMS message, push notification, and in-app notification will be sent to those specific drones the client has selected. However, for this selection, the task will not be posted to the virtual job bulletin and other drones will be unable to apply for this task. If the client clicks option c) Request and post, then both happens—messages will be sent to the selected drones and the task will be searchable and viewable by other “non-selected” drones.

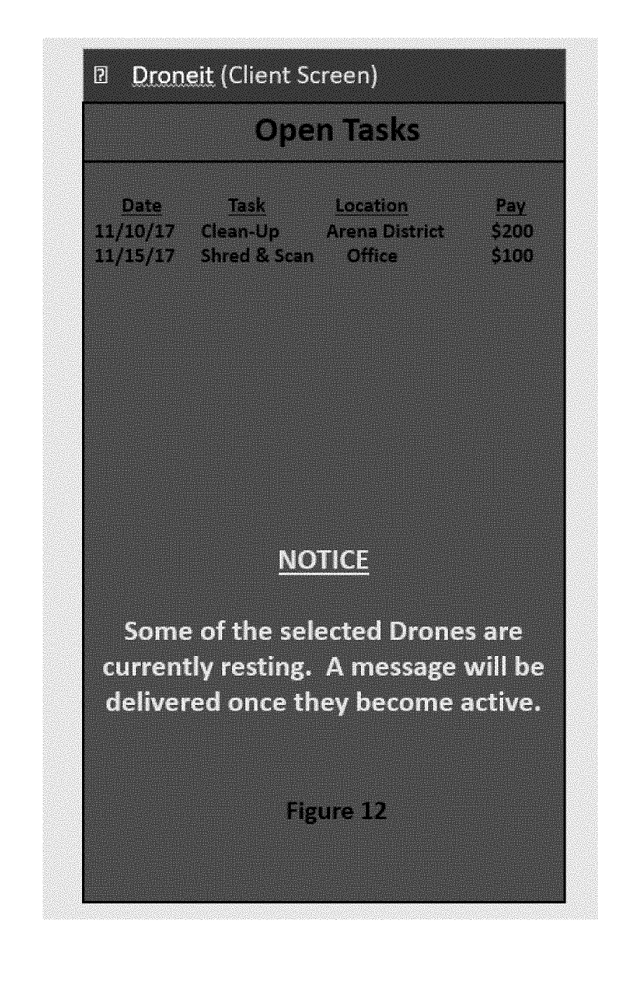

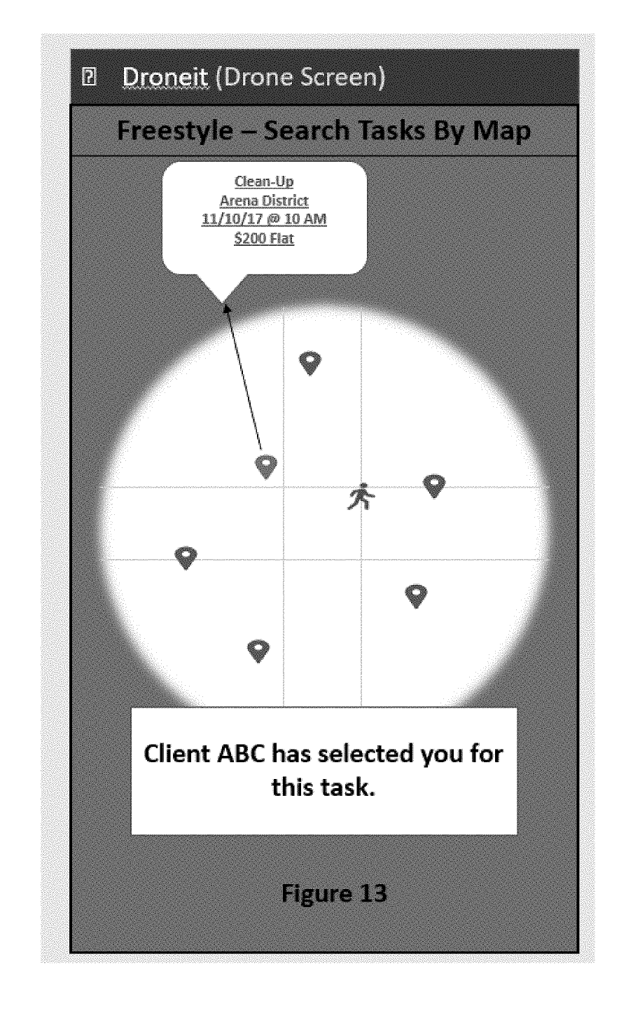

Once the client clicks on one of the three options, the task moves to the “Open Task” folder. FIG. 12 illustrates an example “Open Task” screen. The client knows that “things are in the works” because the client can see that the task is listed (meaning the task has not yet been filled). Essentially, the client now waits for drones to apply/reply and express their interest or disinterest (“decline”) in the task. When a client requests for a particular drone, that drone will be notified through an SMS/text message, a push notification, as well as an in-app notification (e.g., the selected drone will receive a message notifying the drone that he or she was selected for a task with a clickable link). Clicking on the associated link will bring up a “Freestyle—Search Tasks by Map” screen displaying the location of the task as well as a brief description. FIG. 13 illustrates an example screen illustrating the location of the task in relation to the location of the drone. In one embodiment, the task for which the drone is selected is shown on a map that also indicates the location of the selected drone. Clicking on the task icon brings up a task details screen where the drone can review the details of the task and then click to either apply or decline that task.

After successfully applying for a task, “My Open Applications” screen will pop up for the drone with the relevant task listed as a line item. This signifies that a notification has been sent to the client and that the drone should now wait for the client to either schedule or decline the drone. If the client fills the task with another drone, the task will be removed from the list of the drone that was not selected.

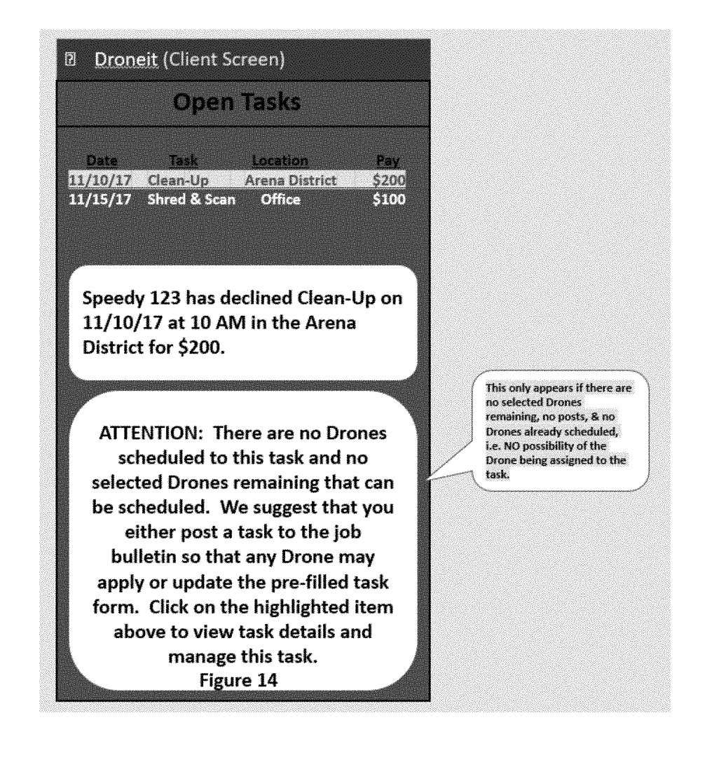

If the drone declines a task, the client will be notified. If all selected drones decline the task, the client will be notified and instructed to consider posting the task on the job bulletin. FIG. 14 illustrates a screen notifying a client that a selected drone has declined the task.

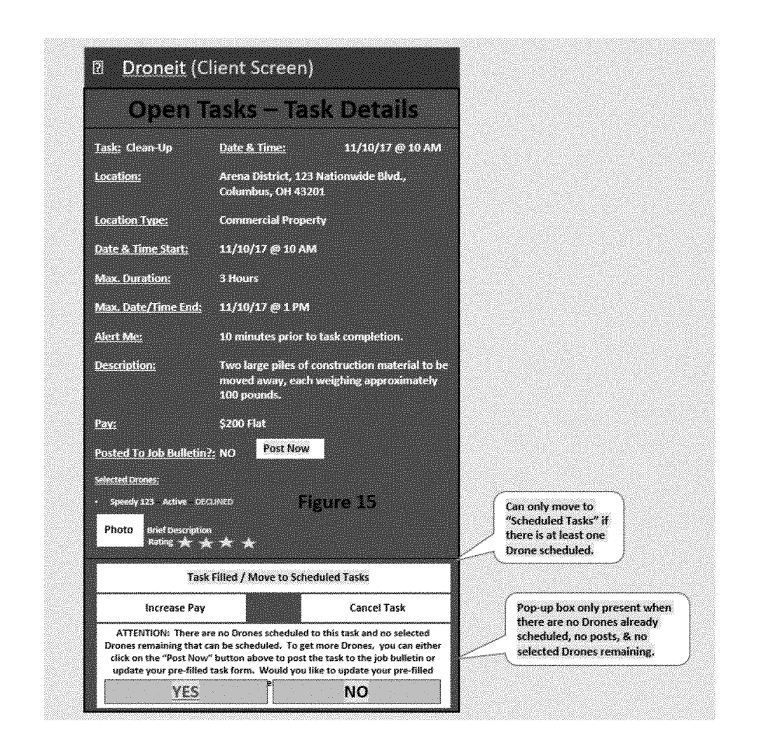

FIG. 15 illustrates a client screen of one embodiment of the invention showing the details of an open task. If a client has scheduled enough drones to an open task, the client can move that task to the “scheduled task” list or screen.

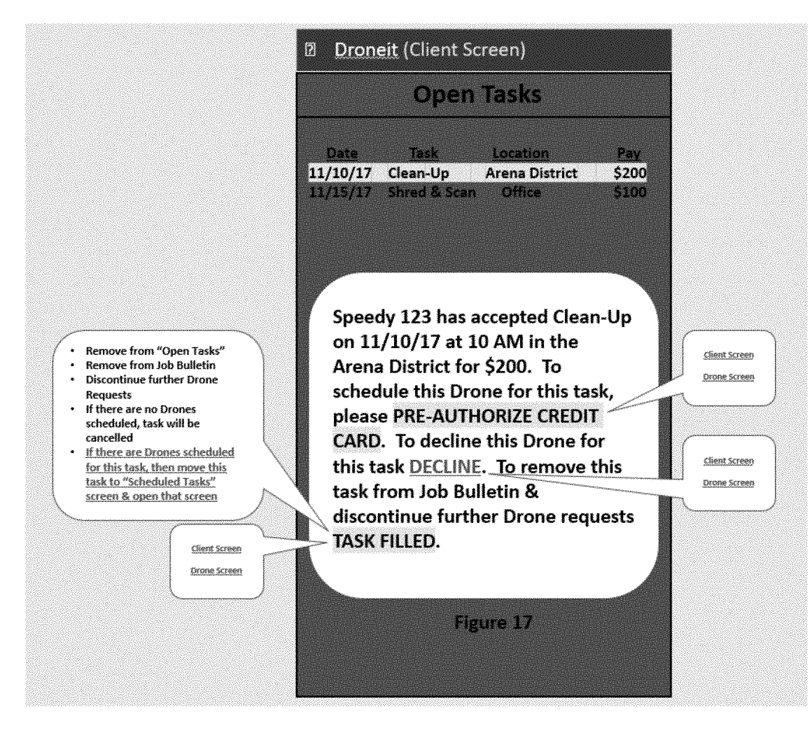

When a drone applies for a task, the client will be notified through an SMS/text message, a push notification, as well as an in-app notification. Clicking on the associated link brings up the “Open Tasks” screen with the relevant task highlighted for clarity. FIG. 17 illustrates an example screen showing an open tasks screen. A prompt will also appear that allows the client to either schedule the drone, decline the drone, or conclude that the task has been filled. In the preferred embodiment, in order to schedule the drone, the client's credit card must first be pre-authorized to ensure sufficient funds. If declining a drone removes any possibility that a task can be filled, the system will alert the client accordingly and provide options to remediate. By clicking on “Task Filled” button, the client is removing the task from the job bulletin and discontinuing any further drone requests the client may have previously entered. In addition, if there is at least one drone scheduled for the task, then the task will be moved from “Open Tasks” folder to “Scheduled Tasks” list or screen.

### “My Scheduled Tasks—Task Details” Screen:

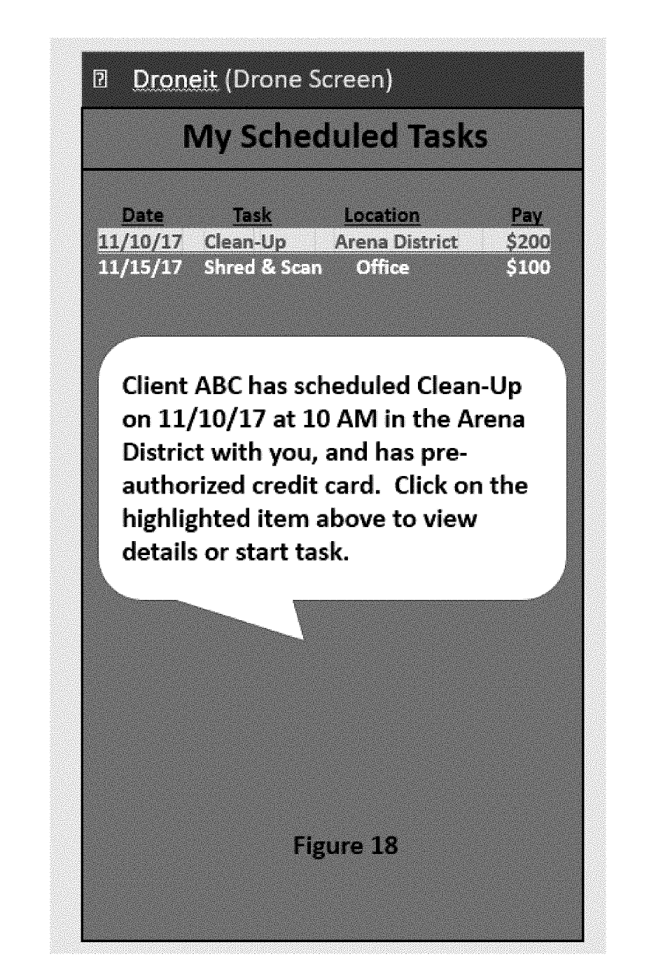

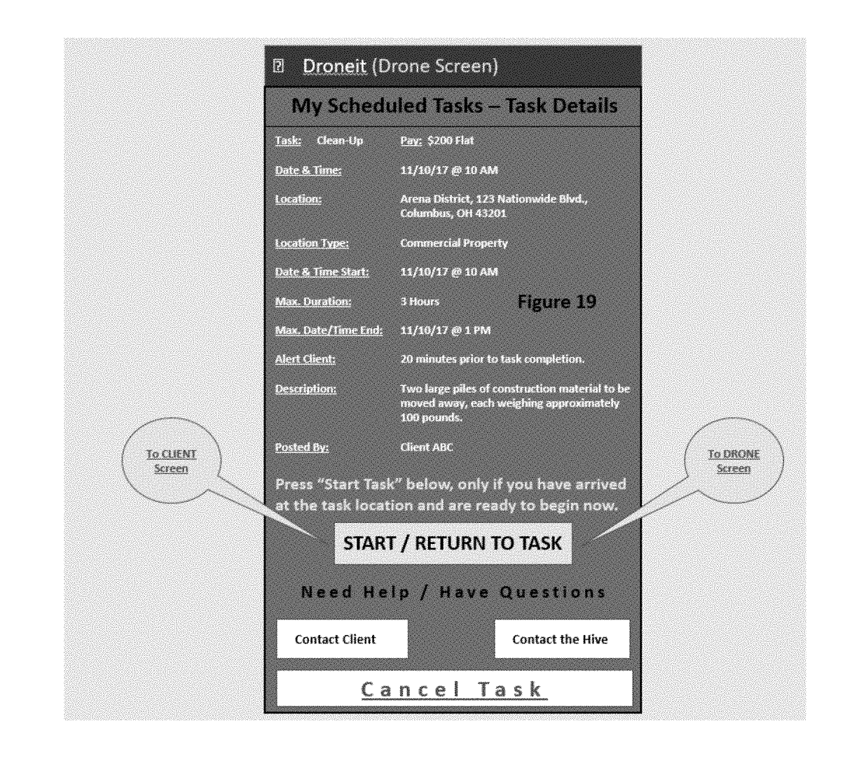

FIG. 18 illustrates an example screen listing scheduled tasks for a particular drone. Once a drone has been scheduled for a task, the task moves from “My Open Applications” list to “My Scheduled Tasks” list. In this screen, drones can view/review the task details and requirements by clicking on the line items. For example, clicking on “Clean Up” line item brings up the “Task Details.” FIG. 19 illustrates an example screen providing task details for a scheduled task. This is also where the drone goes when it is time to start the task. In the preferred embodiment, the drone should be at the task location and ready to start work before clicking on the “Start Task” button. In one embodiment, the drone will not be allowed to start the task until the drone is at the intended task location (the app preferably tracks the drone location using GPS tracking or geolocation services via the drone's phone or computer). When the Drone clicks on the “Start Task” button, an “Active Task” screen is brought up and the clock starts running showing the time spent on the task. There is an option to go back to the “Task Details” screen. Then to return to the “Active Task” screen, the user can click on the “Return to Task” button (previously the “Start Task” button).

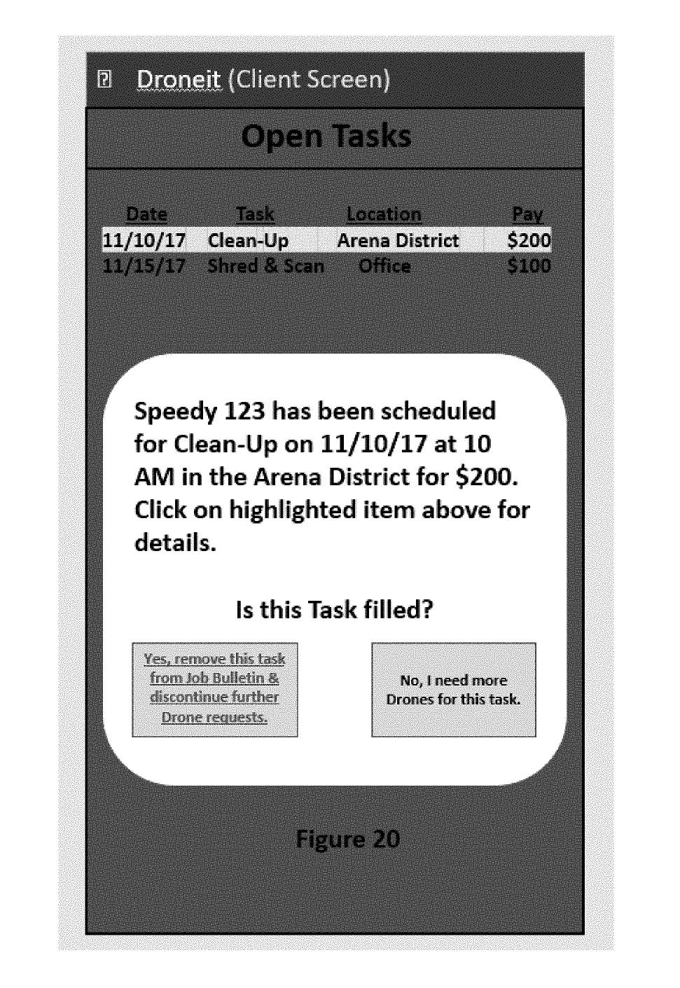

FIG. 20 illustrates one example of a screen allowing the client to indicate the task has been filled or to leave the task open to attract additional drones. If there are no posts to the job bulletin or selected drones remaining, then the app will state—“You had chosen not to post this task to the job bulletin (you did not open the task to any drone who wants to apply) and there are no selected Drones remaining that can fill your need. If you still need more drones for this task, we suggest that you go to Open Tasks-Task Details & select the “Post Now” to job bulletin button. You can also enter a new task form for the same task without cancelling the drones that have already been scheduled for this task.”

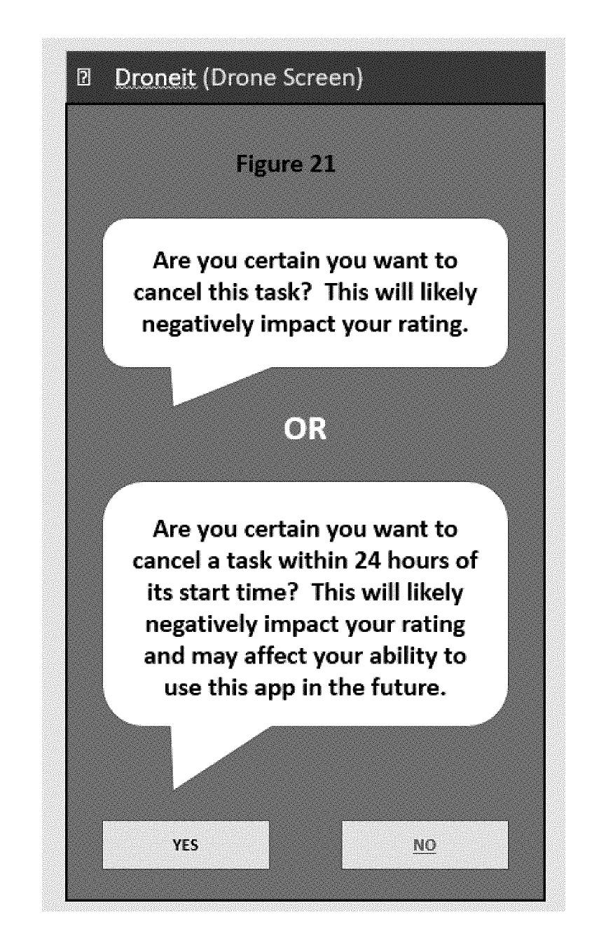

FIG. 21 illustrates an example screen allowing the drone to cancel a scheduled task. Upon cancellation, the client will be notified. If there are no other drones selected and the task has not been posted to a job bulletin, the client will be notified.

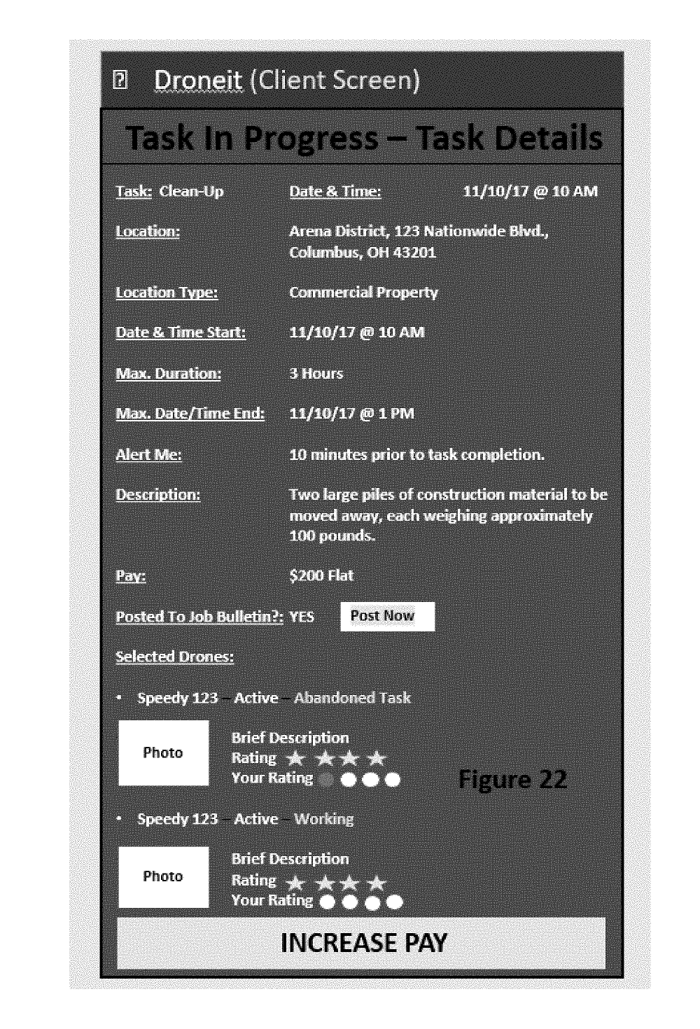

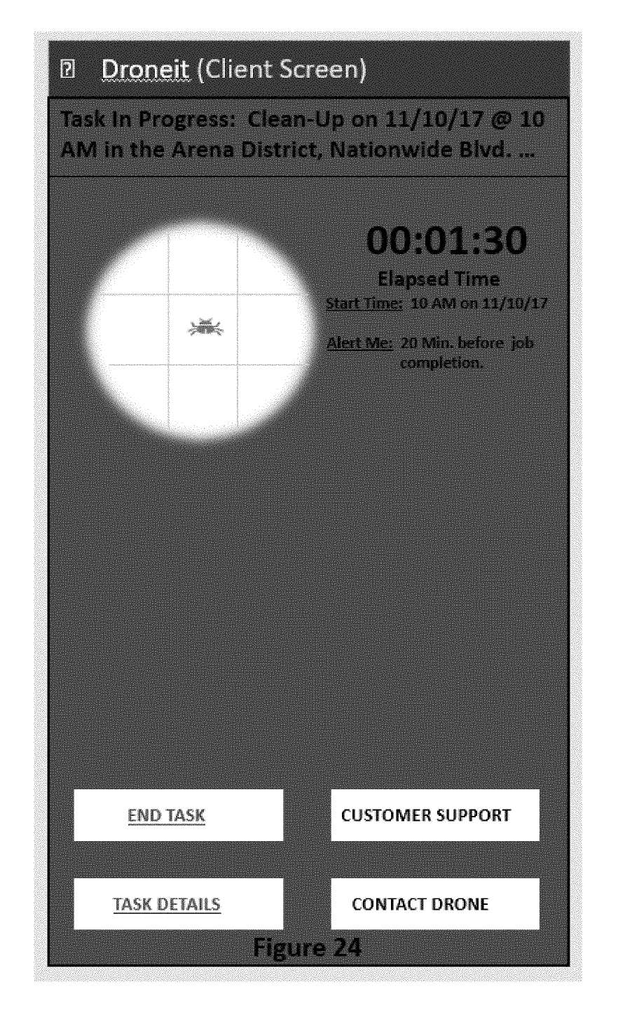

FIG. 22 illustrates one example embodiment of a “Task in Progress—Task Details” screen. FIG. 24 illustrates an example embodiment of a “Task in Progress” screen. The “Task in Progress” is the screen the clients see for tasks in progress, whereas the drones see the “Active Task” screen. Under the “Task in Progress” screen, the user can choose to view “Task Details” which takes the user to the “Task in Progress—Task Details” screen. If the task is already in progress, but there are not enough drones working on the task, the user can choose to increase the pay in order to attract more drones in real-time/on-demand fashion. Or, if the drone is at the task but is threatening to leave because the drone did not realize the scope of the task, the client can also increase the pay for the task.

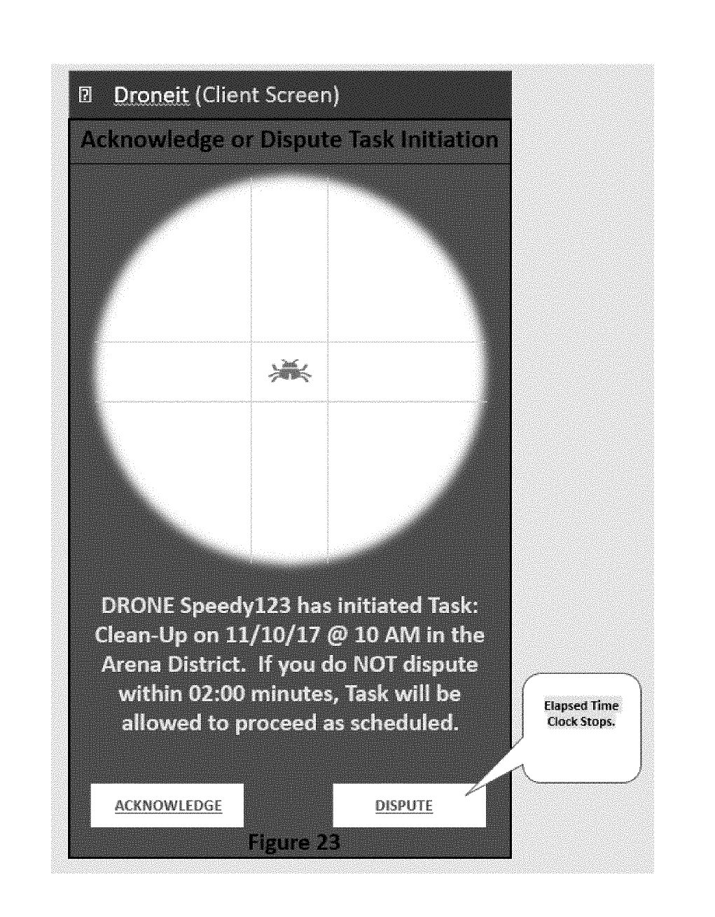

In the drone view of “My Scheduled Tasks—Task Details”, FIG. 19, when the drone clicks “Start Task,” the client gets an SMS/text message, a push notification, and an in-app notification that the drone has started a particular task. FIG. 23 illustrates an example embodiment of the “Acknowledge or Dispute Task Initiation” screen. This screen has a map that shows the drone's location. If the client disputes (because the client sees that the drone is not at the task location), then the clock stops and the drone gets a message asking the drone to reset/restart the clock. On the other hand, if client acknowledges the task initiation, then client sees the “Task in Progress” screen (FIG. 24). The app has a screen for the drone to indicate when the task is complete or if the drone wants to abandon the task. The app also has the ability for the drone to take breaks, thus stopping the clock so that the client does not get charged. Upon task completion, the client will receive a screen with notification of task completion with task start time and end time. The screen will provide the ability for the client to authorize payment or to dispute payment.

If there is no dispute and the task is completed successfully, the system will charge client's credit card and distribute the funds accordingly. Both clients and drones will receive notifications that the payments have been processed and those records will remain available for review. If there is a dispute, the system and/or client can sift through our data and check if the drone was at the intended location at a certain time. The system can confirm and track when the drone pressed “Start Task” and whether that was appropriate. The system can track whether the drone was at the location during the time the task was being worked on. This is just one of the many ways in which the present invention ensures a fair and equitable transaction between clients and drones. If there is a dispute, the drone is notified, and the drone may indicate that he or she will continue with the task completion or dispute the client's claim.

Upon successful completion of the task and payment, the app provides the drone the ability to rate the client and the client the ability to rate the drone. The client is provided a summary of payment details and a list of completed tasks. The drone is also provided a summary of payment details and a list of completed tasks and earnings history.

As described in the figures, the present invention shepherds both clients and drones through the process of:

1) clients selecting drones;
2) drones searching for tasks;
3) acting as an online marketplace that matches supply and demand;
4) pre-authorizing the credit card when scheduling to ensure that there are sufficient funds to pay the drones;
5) allowing the client to schedule multiple drones, asking if they need more after scheduling each drone;
6) warning the client when there is no possibility of filling a task;
7) allowing a client to dispute successful task completion if the work performed is not up to par;
8) handling the payment;
9) keeping track of earned income;
10) keeping track of tasks completed and pay-outs;
11) rating each other; and
12) allowing both the clients and the drones to dispute or cancel.

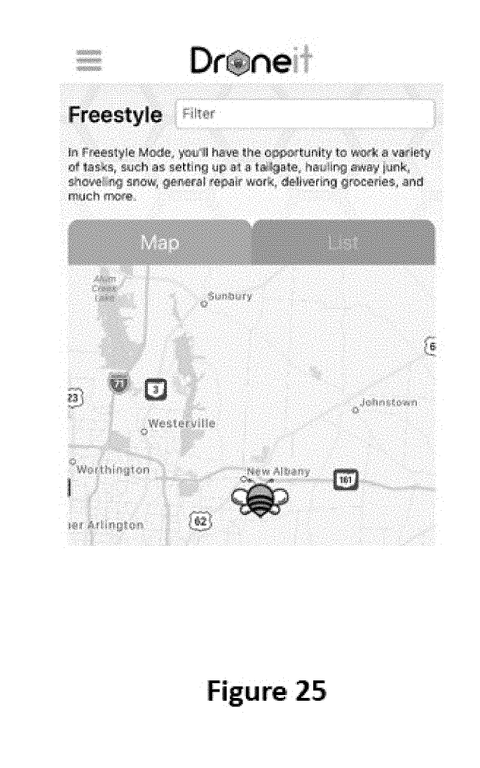

In an alternate embodiment, drones (from the main home screen), can simply tap on a tool to access a map view or a list view of the corresponding category of tasks. For the freestyle tool, drones have the extra capability of being able to filter the map or the list by task category using the field at the top of the screen. For example, a professional dog walker can enter “Dog Walking” in that field and the app will filter out all unrelated tasks and show only those tasks that correspond to his or her profession. FIG. 25 illustrates an example screen interface allowing the filtering of tasks by category.

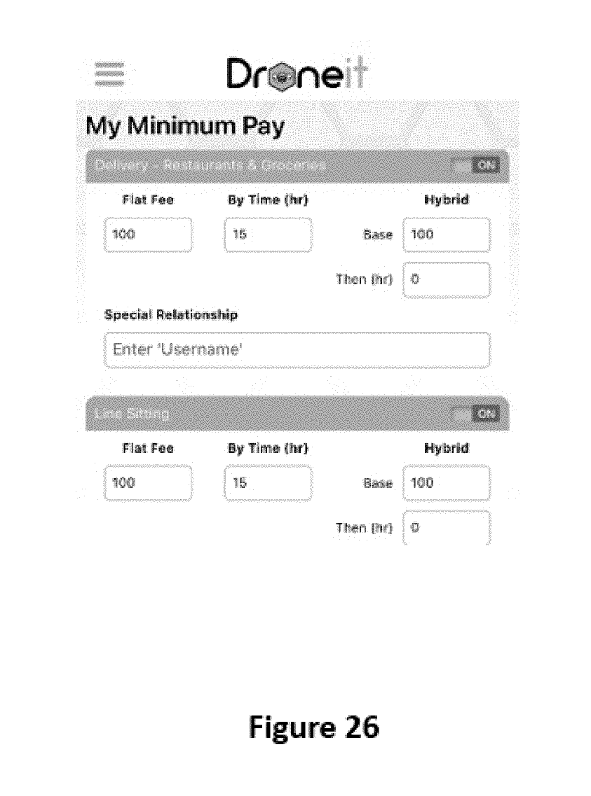

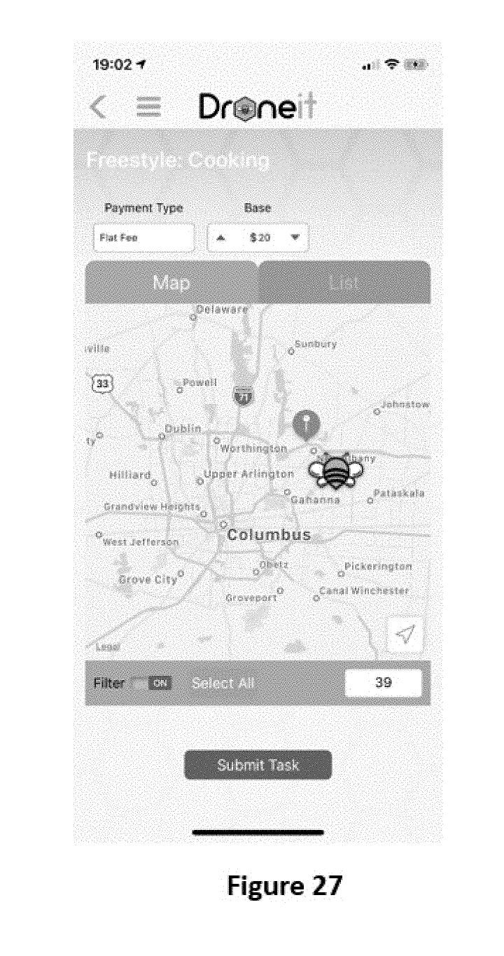

“My Minimum Pay” is another feature of the present invention where users can decide what kinds of tasks they are willing to perform and how much they would require clients to pay them. Game theory suggests that because users are unaware of others' minimum pay requirements, there is some downward pressure on the price balancing against their desire for higher pay. A toggle feature is provided next to each task category that indicates whether the user is a worker (i.e., drone) for that type of task. If the toggle is turned off then the user will not be visible to clients searching for drones under that task category. However, a drone can enter the username of a client under the “Special Relationship” field and upon acceptance by that client, a special relationship is created. This special relationship allows the drone to be accessible to the client even if the relevant task toggle is turned off under My Minimum Pay, meaning that other clients would not be able to find or select this drone unless they also had an established special relationship. In addition, when the client turns on the filter built into the drone selection screens (either map or list view), only those dedicated drones will be visible. Clients can then select all drones with whom they have an established special relationship by tapping the “Select All” button. This allows businesses and other organizations to efficiently fill open shifts with their own established workers. FIG. 26 illustrates an example screen for setting minimum pay requirements and setting special relationships. FIG. 27 illustrates an example screen for setting the filter function built into the drone selection screens.

The “volunteering” tool functions much the same way as the rest of the tools except: 1) it is free to use; 2) there is no payment offer to be entered by the client; and 3) there is no minimum pay to be set by the drone. While the tool may be used to connect volunteer organizations and hopeful volunteers with one another, we believe that its main application will be in staffing events using an organization's established volunteers. As discussed above, the Special Relationship function allows clients to connect with their own, established group of drones by linking them through a special relationship. For volunteer organizations and community groups, it represents a free and effortless way to coordinate events; simply turn on the filter and select all dedicated volunteers to communicate the need to staff an event. The app conveys the relevant information to the volunteers in a clear, organized, and aesthetically-pleasing manner while the volunteers can directly respond by tapping on the push notifications. As volunteers are scheduled, the administrator can keep track of this progress using the app. Once all the open positions are filled, the administrator is able to send a push notification alerting the remaining volunteers of the change in status. The administrators will be alerted through the app when the volunteers arrive at the venue and are ready to begin their tasks; typically, the administrator or a representative will be present to greet the volunteers and direct them to the needed areas. Finally, upon completion, the app can provide the participation hours, date, and time to both parties, and this record will always be accessible through the users' accounts.

A “delivery” tool can be utilized by either the customers or the restaurants: 1) customers can order directly from any restaurant and then separately use the tool to implement the delivery; or 2) restaurants can offer the delivery service to the customers while implementing the process using the app. The client enters both the pick-up and delivery addresses, but the pick-up location will be designated as the task location; hence, the delivery drone will alert the client once he has arrived at the restaurant. The start time corresponds to the time when the food should be ready for pick-up (when the client expects the drone to arrive at the restaurant) and the max duration indicates the client's time limit for the task to be completed. Upon task initiation, the client will be able to verify that the drone is at the correct location and track its progress through the app's geolocation dashboard. An alert will also be provided prior to the drone's arrival at the delivery location, in accordance with the client's instructions. If desired, a brief instruction can be supplied to the drone to ensure that the correct items are picked up or to request for extra napkins and utensils.

To ensure that restaurants that offer delivery service through this app have access to consistent pricing and delivery personnel, special relationships need to be created between a group of restaurants and the delivery drones they share. The Special Relationship function previously discussed facilitates this process by connecting clients to their own, established crew of workers. Using this function, restaurants can connect with a pre-arranged group of delivery drones thereby allowing them to confidently offer the delivery service to their customers at a set price. The restaurants can then pass the cost of the delivery service on to their customers to varying degrees and at their own discretions.

While certain embodiments of the present invention are described in detail above, the scope of the invention is not to be considered limited by such disclosure, and modifications are possible without departing from the spirit of the invention as evidenced by the following claims:

What is claimed is:

1. A method for displaying task information on a collection of graphical user interfaces relating to locating workers and facilitating the matching of clients with workers, selecting workers and authenticating work performance and attendance, the method comprising the steps of:
displaying a first space on the collection of graphical user interfaces for a first client to input a first task to be completed;
displaying a second space on the collection of graphical user interfaces for the first client to input a payment amount or hourly rate;
displaying a third space on the collection of graphical user interfaces for inputting a location of the first task;
locating a first set of workers available for completing the task within a predetermined geographic distance from the location of the first task;
displaying on a first map a first symbol representing the location of the first task;
displaying on the first map a plurality of selectable symbols, each of the plurality of selectable symbols representing one of the first set of workers available for completing the task;
displaying each of the plurality of selectable symbols at the location on the map where each of the first set of workers is located;
providing the ability to view the profile of each of the first set of workers available for completing the task;
providing the ability for the first client to select one or more of the first set of workers to send a task request;
sending the selected one or more of the first set of workers a request to accept or decline the task request;
authorizing a first worker who accepts the task request;
tracking the time the first worker is at the location of the first task; and
providing the ability for the first client to dispute task completion by the first worker.

2. A method according to claim 1, further comprising the steps of:
providing the ability for the first client to change the payment amount or hourly rate to a new payment amount or hourly rate; and
dynamically changing the color of the plurality of selectable symbols representing one of the first set of workers based on the new payment amount or hourly rate.

3. A method according to claim 1, further comprising the step of:
dynamically changing the color of each of the plurality of selectable symbols representing one of the first set of workers based on whether the payment amount or hourly rate meets minimum pay requirement of each of the first set of workers.

4. A method according to claim 1, further comprising the step of:
providing the ability to post the first task to a task bulletin.

5. A method according to claim 1, further comprising the step of:
determining if the first worker is at the location of the first task;
providing the ability for the first worker to start the first task only when the first worker is at the location of the first task.

6. A method according to claim 5, further comprising the steps of:
providing the ability for the first worker to pause work on the first task and to return to work on the first task; and
storing the duration of time the first worker is working on the first task.

7. A method according to claim 5, further comprising the step of:
displaying the elapsed time the first worker is at the location of the first task.

8. A method according to claim 1, further comprising the steps of:
determining the geographic location of a second worker;
searching for available tasks located within a predetermined distance from the second worker;
displaying on a second map a second symbol representing the location of the second worker;
displaying on the second map a second set of selectable symbols, the second set of selectable symbols representing a first set of tasks in need of completion;
displaying each of the first set of tasks at the location on the map where each of the first set of tasks is located;
providing the ability for the second worker to select one of the first set of tasks to apply for; and
sending at least one application for the selected task to the first client.

9. A method according to claim 1, further comprising the step of:
displaying a fourth space on the collection of graphical user interfaces for the first client to input a delivery address for a package delivery;
wherein the location of the first task is the pick-up location for the package.

10. A method according to claim 1, further comprising the steps of:
providing a toggle feature for task categories for the first worker to indicate their availability or unavailability for each task category; and
filtering out the first worker for tasks where the first worker has indicated they are not available.

11. A method according to claim 10, further comprising the step of:
providing the ability to indicate special relationships between clients and the first worker on the collection of graphical user interfaces;
wherein a special relationship between a particular client and worker trumps an indication of unavailability for the task categories.

12. A method for displaying task information on a collection of graphical user interfaces relating to locating workers and facilitating the matching of clients with workers, selecting workers and authenticating work performance and attendance, the method comprising the steps of:
displaying a first space on the collection of graphical user interfaces for a first client to input a first task to be completed;
displaying a second space on the collection of graphical user interfaces for the first client to input a payment amount or hourly rate;
displaying a third space on the collection of graphical user interfaces for inputting a location of the first task;
locating a first set of workers available for completing the task within a predetermined geographic distance from the location of the first task;
displaying on a first map a first symbol representing the location of the first task;
displaying on the first map a plurality of selectable symbols, each of the plurality of selectable symbols representing one of the first set of workers available for completing the task;
displaying each of the plurality of selectable symbols at the location on the map where each of the first set of workers is located;
providing the ability to view the profile of each of the first set of workers available for completing the task;
providing the ability for the first client to select one or more of the first set of workers to send a task request;
sending the selected one or more of the first set of workers a request to accept or decline the task request;
authorizing a first worker who accepts the task request;
tracking the time the first worker is at the location of the first task; and
providing the ability for the first client to dispute task completion by the first worker;
providing the ability for the first client to change the payment amount or hourly rate to a new payment amount or hourly rate; and
dynamically changing the color of the plurality of selectable symbols representing one of the first set of workers based on the new payment amount or hourly rate.

13. A method according to claim 12, further comprising the step of:
dynamically changing the color of each of the plurality of selectable symbols representing one of the first set of workers based on whether the payment amount or hourly rate meets minimum pay requirement of each of the first set of workers.

14. A method according to claim 1, further comprising the step of:
providing the ability to post the first task to a task bulletin.

15. A method according to claim 1, further comprising the steps of:
determining if the first worker is at the location of the first task; and
providing the ability for the first worker to start the first task only when the first worker is at the location of the first task.

16. A method according to claim 15, further comprising the steps of:
providing the ability for the first worker to pause work on the first task and to return to work on the first task; and
storing the duration of time the first worker is working on the first task.

17. A method according to claim 15, further comprising the step of:
displaying the elapsed time the first worker is at the location of the first task.

18. A method according to claim 1, further comprising the steps of:
determining the geographic location of a second worker;
searching for available tasks located within a predetermined distance from the second worker;
displaying on a second map a second symbol representing the location of the second worker;
displaying on the second map a second set of selectable symbols, the second set of selectable symbols representing a first set of tasks in need of completion;
displaying each of the first set of tasks at the location on the map where each of the first set of tasks is located;
providing the ability for the second worker to select one of the first set of tasks to apply for; and
sending at least one application for the selected task to the first client.

19. A method according to claim 1, further comprising the step of:
displaying a fourth space on the collection of graphical user interfaces for the first client to input a delivery address for a package delivery;
wherein the location of the first task is the pick-up location for the package.

20. A method according to claim 1, further comprising the steps of:
providing a toggle feature for task categories for the first worker to indicate their availability or unavailability for each task category; and
filtering out the first worker for tasks where the first worker has indicated they are not available.

21. A method according to claim 10, further comprising the step of:
providing the ability to indicate special relationships between clients and the first worker on the collection of graphical user interfaces;
wherein a special relationship between a particular client and worker trumps an indication of unavailability for the task categories.

22. A method for displaying task information on a collection of graphical user interfaces relating to locating workers and facilitating the matching of clients with workers, selecting workers and authenticating work performance and attendance, the method comprising the steps of:
displaying a first space on the collection of graphical user interfaces for a first client to input a first task to be completed;
displaying a second space on the collection of graphical user interfaces for the first client to input a payment amount or hourly rate;
displaying a third space on the collection of graphical user interfaces for inputting a location of the first task;
locating a first set of workers available for completing the task within a predetermined geographic distance from the location of the first task;
displaying on a first map a first symbol representing the location of the first task;
displaying on the first map a plurality of selectable symbols, each of the plurality of selectable symbols representing one of the first set of workers available for completing the task;
displaying each of the plurality of selectable symbols at the location on the map where each of the first set of workers is located;
providing the ability to view the profile of each of the first set of workers available for completing the task;
providing the ability for the first client to select one or more of the first set of workers to send a task request;
sending the selected one or more of the first set of workers a request to accept or decline the task request;
authorizing a first worker who accepts the task request;
tracking the time the first worker is at the location of the first task;
providing the ability for the first client to dispute task completion by the first worker;
dynamically changing the color of each of the plurality of selectable symbols representing one of the first set of workers based on whether the payment amount or hourly rate meets the minimum pay requirement of each of the first set of workers;
providing the ability for the first client to change the payment amount or hourly rate to a new payment amount or hourly rate; and
dynamically changing the color of the plurality of selectable symbols representing one of the first set of workers based on the new payment amount or hourly rate.

23. A method according to claim 22, further comprising the step of:
allowing the first client to indicate the first task has been filled or to leave the first task open to attract additional workers.

24. A method according to claim 5, further comprising the step of:
providing the ability for the first client to acknowledge or dispute the initiation of the first task based on whether the first worker has arrived at the location of the first task.

25. A method according to claim 15, further comprising the step of:
providing the ability for the first client to acknowledge or dispute the initiation of the first task based on whether the first worker has arrived at the location of the first task.
